(19) United States
(12) Patent Application Publication
(10) Pub. No.: US 2019/0308510 A1
(43) Pub. Date: Oct. 10, 2019

(54) METHOD, APPARATUS, AND SYSTEM FOR PROVIDING A TIME-BASED REPRESENTATION OF A CHARGE OR FUEL LEVEL

(71) Applicant: HERE GLOBAL B.V., Eindhoven (NL)

(72) Inventors: Jerome BEAUREPAIRE, Berlin (DE); Stephan SCHEUNIG, Wanditz (DE)

(21) Appl. No.: 15/947,514

(22) Filed: Apr. 6, 2018

(51) Int. Cl. B60L 11/18; B60L 15/20; B60K 37/02

(52) U.S. Cl. CPC B60L 11/1861; B60L 11/184; B60L 2260/52; B60K 37/02; B60L 2260/54; B60L 15/2045

(57) ABSTRACT

An approach is provided for a time-based representation of an energy level (e.g., charge or fuel level) of a vehicle or device. The approach involves, for instance, determining a remaining energy level of a vehicle or device. The approach also involves computing a predicted time that the vehicle can be operated based on the remaining energy level. The approach further involves presenting a user interface depicting a representation of the predicted time as an indicator of an energy status of the vehicle.

### BACKGROUND

Driving is a hugely complex task that requires sustained and selection attention. Drivers need to perform an array of cognitive, physical, and visual activities while contending with more traffic than ever before. As a result, vehicle manufacturers and related service providers face significant technical challenges to reducing a driver's cognitive load. Because of the increasing popularity of electric vehicles, one particular area of development has been in reducing the cognitive load with respect to battery range anxiety, including the cognitive load associated with thinking ahead about when and where to recharge or refuel a vehicle.

### SOME EXAMPLE EMBODIMENTS

Therefore, there is a need for an approach for reducing this range anxiety and associated cognitive load by providing a time-based representation of energy levels (e.g., charge or fuel levels) of a vehicle and/or another other energy-using device that can be more easily understood by a user.

According to one embodiment, a computer-implemented method comprises determining a remaining energy level of a vehicle or device. The method also comprises computing a predicted time that the vehicle or device can be operated based on the remaining energy level. The method further comprises presenting a user interface (e.g., an interactive user interface) depicting a representation of the predicted time as an indicator of an energy status of the vehicle or device.

According to another embodiment, an apparatus comprises at least one processor, and at least one memory including computer program code for one or more computer programs, the at least one memory and the computer program code configured to, with the at least one processor, cause, at least in part, the apparatus to determine a remaining energy level of a vehicle or device. The apparatus is also caused to compute a predicted time that the vehicle or device can be operated based on the remaining energy level. The apparatus is further caused to present a user interface depicting a representation of the predicted time as an indicator of an energy status of the vehicle or device.

According to another embodiment, a non-transitory computer-readable storage medium carries one or more sequences of one or more instructions which, when executed by one or more processors, cause, at least in part, an apparatus to determine a remaining energy level of a vehicle or device. The apparatus is also caused to compute a predicted time that the vehicle or device can be operated based on the remaining energy level. The apparatus is further caused to present a user interface depicting a representation of the predicted time as an indicator of an energy status of the vehicle or device.

According to another embodiment, an apparatus comprises means for determining a remaining energy level of a vehicle or device. The apparatus also comprises means for computing a predicted time that the vehicle or device can be operated based on the remaining energy level. The apparatus further comprises means for presenting a user interface depicting a representation of the predicted time as an indicator of an energy status of the vehicle or device.

According to another embodiment, a computer-implemented method comprises recording a usage history, a usage pattern, or combination thereof associated with an operation of a vehicle or device by a user. The method also comprises generating a representation of a remaining energy level of the vehicle or device. The representation indicates a predicted time that the vehicle or device can be operated using the remaining energy level. The method further comprises presenting a user interface depicting the representation as an indicator of an energy status of the vehicle.

According to another embodiment, an apparatus comprises at least one processor, and at least one memory including computer program code for one or more computer programs, the at least one memory and the computer program code configured to, with the at least one processor, cause, at least in part, the apparatus to record a usage history, a usage pattern, or combination thereof associated with an operation of a vehicle or device by a user. The apparatus is also caused to generate a representation of a remaining energy level of the vehicle or device. The representation indicates a predicted time that the vehicle or device can be operated using the remaining energy level. The apparatus is further caused to present a user interface depicting the representation as an indicator of an energy status of the vehicle.

According to another embodiment, a non-transitory computer-readable storage medium carries one or more sequences of one or more instructions which, when executed by one or more processors, cause, at least in part, an apparatus to record a usage history, a usage pattern, or combination thereof associated with an operation of a vehicle or device by a user. The apparatus is also caused to generate a representation of a remaining energy level of the vehicle or device. The representation indicates a predicted time that the vehicle or device can be operated using the remaining energy level. The apparatus is further caused to present a user interface depicting the representation as an indicator of an energy status of the vehicle.

According to another embodiment, an apparatus comprises means for recording a usage history, a usage pattern, or combination thereof associated with an operation of a vehicle or device by a user. The apparatus also comprises means for generating a representation of a remaining energy level of the vehicle or device. The representation indicates a predicted time that the vehicle or device can be operated using the remaining energy level. The apparatus further comprises means for presenting a user interface depicting the representation as an indicator of an energy status of the vehicle.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing a time-based representation of an energy level, according to one embodiment;

FIGS. 2A and 2B are diagrams illustrating examples of a time-based representation of an energy level, according to one embodiment;

FIG. 3 is a diagram of the components of an energy management platform, according to one embodiment;

FIG. 4 is a flowchart of a process for providing a time-based representation of an energy level, according to one embodiment;

FIG. 5A illustrates an example of generating a time-based representation of a remaining energy level which accounts for a reserve level and a buffer level, according to one embodiment;

FIGS. 5B-5D are diagrams illustrating example user interfaces used in the process of FIG. 4, according to one embodiment;

FIG. 5E is a diagram illustrating an example user interface depicting an evolution of a vehicle/device's remaining energy level, according to one embodiment;

FIG. 6 is a flowchart of a process for recommending energy replenishment parameters, according to one embodiment;

FIG. 7 is a diagram illustrating an example user interface used in the process of FIG. 6, according to one embodiment;

FIG. 8 is a diagram of a geographic database, according to one embodiment;

FIG. 9 is a diagram of hardware that can be used to implement an embodiment;

FIG. 10 is a diagram of a chip set that can be used to implement an embodiment; and

FIG. 11 is a diagram of a mobile terminal (e.g., handset or vehicle or part thereof) that can be used to implement an embodiment.

### DESCRIPTION OF SOME EMBODIMENTS

Examples of a method, apparatus, and computer program for providing a time-based representation of a charge or fuel level of vehicle or device are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

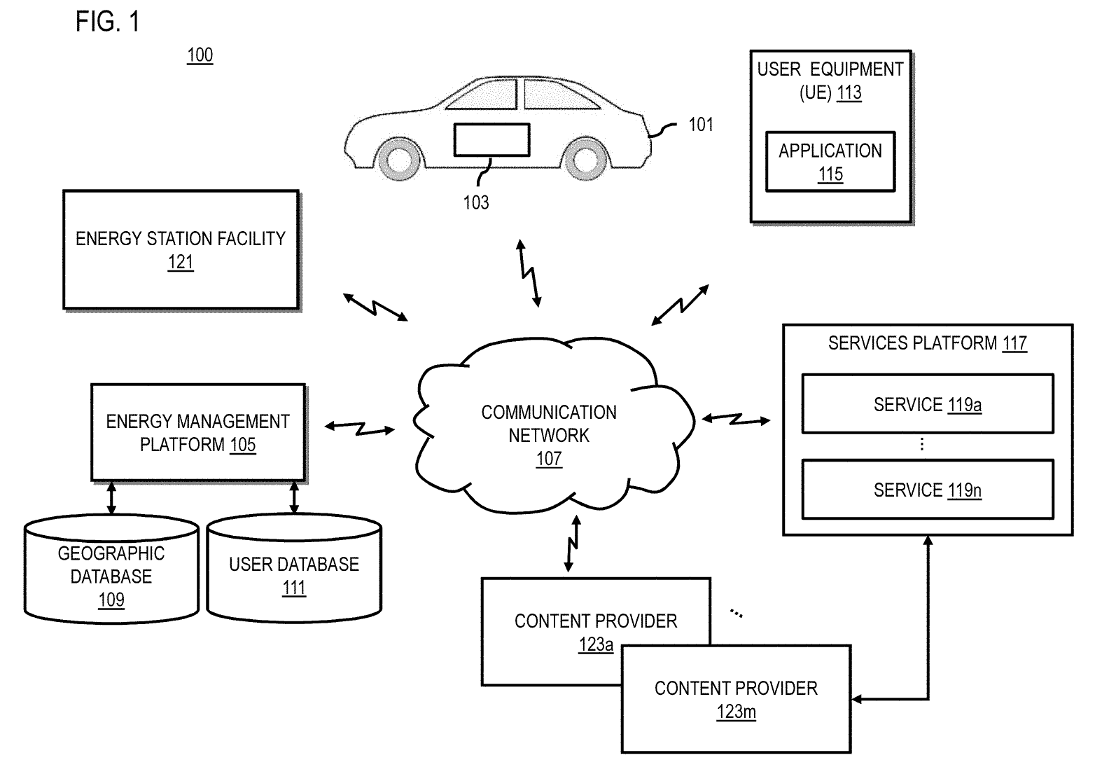

FIG. 1 is a diagram of a system capable of providing a time-based representation of an energy level, according to one embodiment. With more vehicles (e.g., an electric vehicle 101) of greater complexity on the road than ever before, drivers are subjected to potentially overwhelming amounts of data, thereby causing many drivers to feel stressed out, anxious, and unable to relax. However, in these stressful driving environments, drivers still need to perform an array of cognitive, physical, and visual activities while contending with more traffic and data than ever before. As a result, car manufacturers and service providers face significant technical challenges over determining how to present in-vehicle information to drivers to reduce cognitive loads and provide a less anxious driving experience so that drivers can make better driving decisions.

For example, one source of anxiety or cognitive load on drivers is “range anxiety” (e.g., when driving in an electric vehicle 101 in particular, but also in any vehicle in general). This range anxiety refers, for instance, to when the drivers worry over when they will runout of battery charge or fuel. As a result, drivers may tend to act conservatively and unnecessarily recharge/refuel “just in case” to relieve range anxiety. However, this unnecessarily recharging/refueling can have potential negative sides effects. For example, particularly with respect electric car recharging stations, recharging stations are still relatively rare compared to traditional fueling stations, making recharging spots these stations also relatively rare. Accordingly, vehicles 101 that unnecessarily charge or charge for unnecessarily long times can occupy valuable charging spaces that would otherwise be better used by other vehicles 101 that have actual charging needs (e.g., vehicles 101 with almost depleted batteries, vehicles with planned trips that exceed their currently available range, etc.). In addition, unnecessary charging or overcharging of the batteries in the vehicles 101 may degrade the performance of those batteries over time, leading to decrease battery lifespan, charge capacity, output voltage, etc.

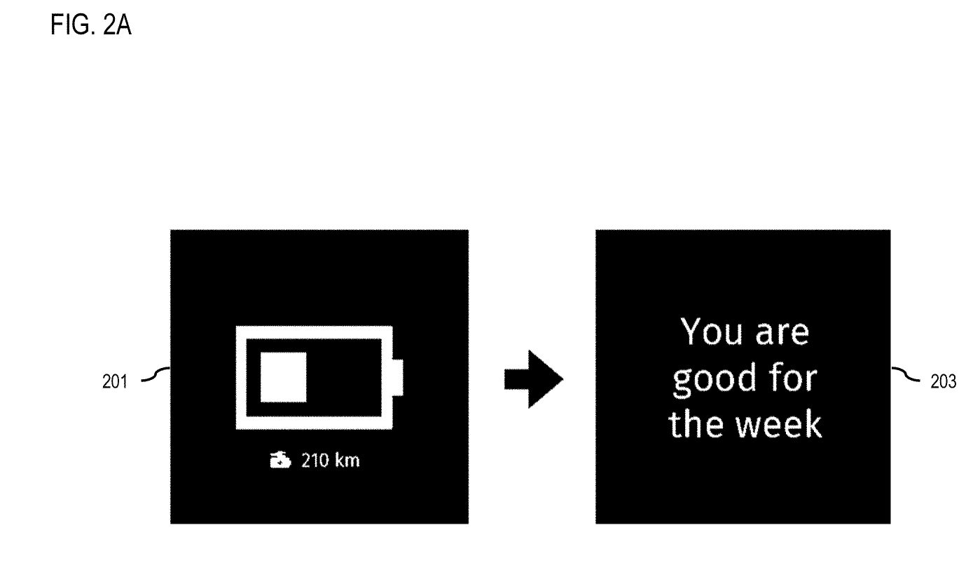

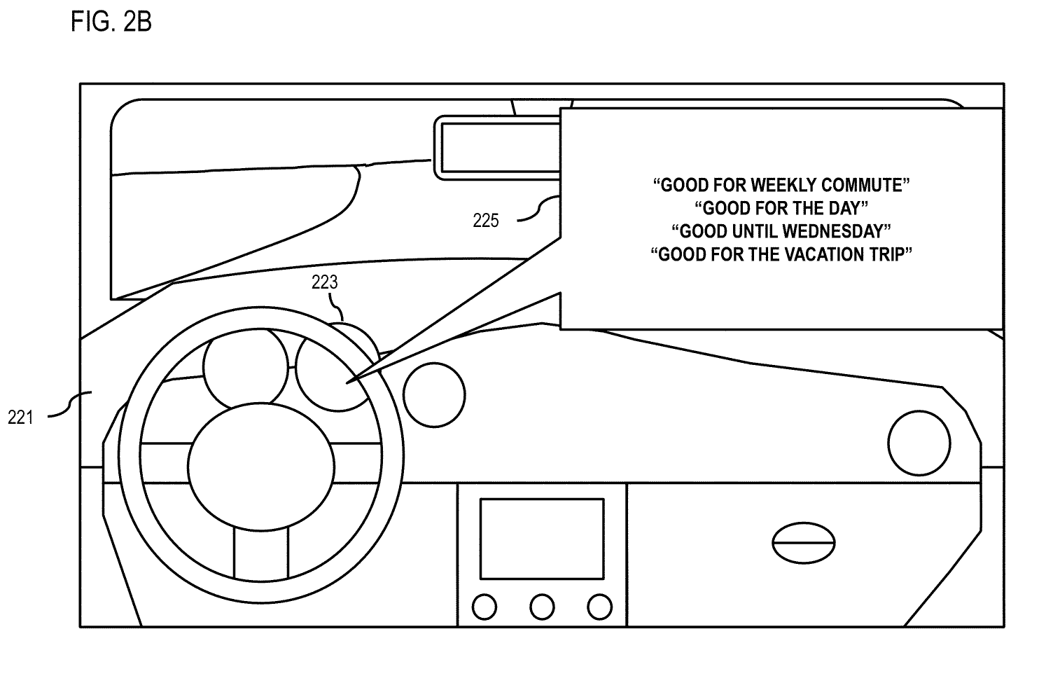

To address these technical challenges, the system 100 introduces a capability to provide an intuitive, meaningful, and relevant interface for drivers with regards to when to recharge or refuel a vehicle 101. More specifically, the system 100 provides a user interface (UI) that allows drivers or other users to easily identify when they will need to fill up their battery charges or fuel tanks by considering their driving usage habits and patterns to predict how the user can expect to operate the vehicle 101 given a current charge or fuel level. In one embodiment, as shown in FIG. 2, the system 100 replaces a traditional representation 201 of an energy status (e.g., a battery charge level or a fuel level) of a vehicle 101 with a time-based representation 203 of the energy status. For example, the traditional representation 201 typically will depict a percent charge remaining (e.g., illustrated by the fill level of a battery icon) and also an estimated remaining range of 210 km as shown. However, the traditional representation 201 may not be intuitive to many users (especially users not familiar with electric car range and performance) and require that a user mentally estimate what that range or battery capacity means in actual use, thereby increasing cognitive load and providing a less than ideal user experience.

In contrast, the time-based representation 203 (e.g., introduced according to the embodiments described herein) introduces a more intuitive representation of the remaining energy level. For example, instead of presenting a traditional charge or fuel level and/or remaining distance range, the time-based representation 203 indicates how much time the user can operate the vehicle given the current charge by considering the user's habits (or even the habits of multiple car users in case a car is shared such as shared among family members) and the remaining charge or fuel level. In this example, the user's habits indicate that user drives an average of 30 km per day. Therefore, with an estimated 210 km range, the system 100 predicts that user can drive for one week on the current charge level. This determination can then be presented in an intuitive manner by, for instance, presenting a message that “You are good for week” as shown in the time-based representation 203 to reassure the user that the user need not worry about the charge level for one week, thereby reducing range anxiety. Also, because the representation 203 is presented in plain intuitive language, the system 100 reduces the cognitive load on the user by reducing a need for the user to translate the time-based representation 203 to something more meaningful to the user.

FIG. 2B illustrates other examples of intuitive time-based representations of a charge or fuel level of a vehicle 221, according to one embodiment. In the example of FIG. 2B, in place of a traditional battery or fuel gauge, the vehicle uses an instrument cluster display 223 to presented time-based representations 225 of the remaining fuel level. As shown, the display 223 can use plain language descriptions to convey the computed time-based representations 225 more intuitively as described above. For example, the display 223 can be dynamically updated based on past and current usage estimates to present any of the following time-based indicators of an energy status (e.g., charge remaining) of the vehicle 221 such as but not limited to: “Good for weekly commute”, “Good for the day”, “Good until Wednesday”, and “Good for the vacation trip”. The illustrated intuitive messages can replicate natural speech often used by one person to describe the fuel or charge level of a car to another person, thereby making the provided information more easily understood by the user while imposing a smaller cognitive load.

It is noted that the time-based representation 203 shown in FIG. 2A and the time-based representations 225 of FIG. 2B are provided by way of illustration and not as limitations. Other examples of time-based representations of energy levels are described in more detail below.

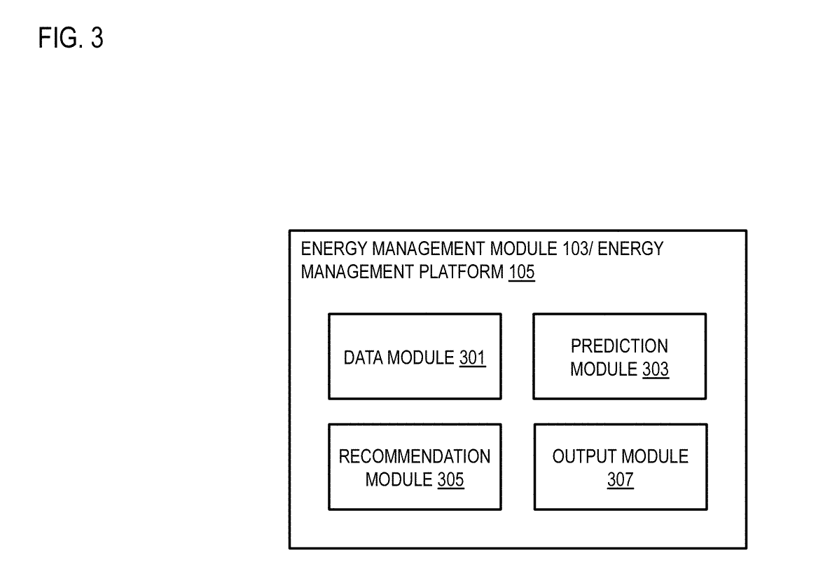

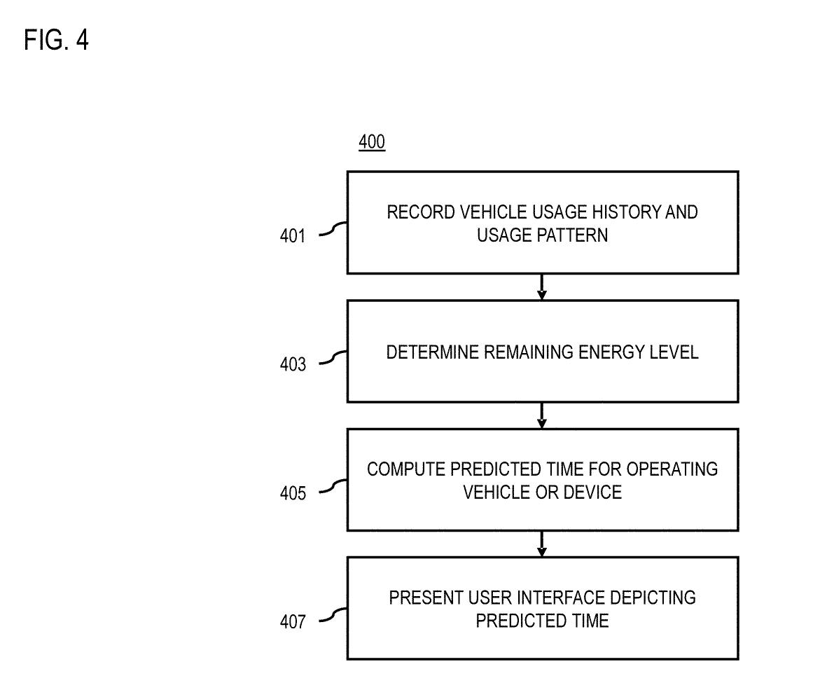

In one embodiment, an energy management module 103 in the vehicle 101 (e.g., a client-side or local component) and/or an energy management platform 105 (e.g., a server side or cloud component) can perform one or more functions related to providing a time-base representation of an energy level. The energy management module 103 and the energy management platform 105 can act alone or in combination (e.g., using a client-server architecture over a communication network 107), and have connectivity to a geographic database 109 (e.g., storing digital map data) and a user database 111 (e.g., storing user vehicle usage data, vehicle usage patterns, and related data). FIG. 3 is a diagram of the components of the energy management module 103 and/or energy management platform 105, according to one embodiment. By way of example, the energy management module 103 and/or energy management platform 105 may include one or more components for providing a time-based representation of an energy level of a vehicle (e.g., vehicle 101) or a device (e.g., a user equipment (UE) device 113 executing an energy management application 115). In one embodiment, the energy management module 103 and/or the energy management platform 105 include a data module 301, prediction module 303, recommendation module 305, and output module 307. It is contemplated that the functions of these components may be combined in one or more components or performed by other components with similar functionalities (e.g., a services platform 117, any of the services 119a-119n of the services platform 117, etc.). The above presented modules and components of the energy management module 103 and/or the energy management platform 105 can be implemented in hardware, firmware, software, or a combination thereof. Though depicted as separate entities in FIG. 1, it is contemplated that the energy management module 103 and/or the energy management platform 105 may be implemented as a module of any of the components of the system 100. In another embodiment, one or more of the modules 301-307 may be implemented as a cloud-based service, local service, native application, or combination thereof. The functions of the energy management module 103 and/or energy management platform 105 and the modules 301-307 are discussed with respect to FIGS. 4-7 below.

In addition, although the various embodiments described herein are discussed with respect to electric vehicle battery charge levels, it is contemplated that the embodiments are also applicable to any other type of energy source (e.g., gasoline, hydrogen, natural gas, and/or any other type of fuel). Accordingly, the terms energy level, charge level, and fuel level can be used interchangeably in the embodiments described herein. It is further contemplated that the energy levels can be for any type of device (e.g., electronic devices such as phones, computers, etc.) and is not limited to vehicles. Accordingly, the terms vehicle and device can be used interchangeably according to the embodiments described herein. In yet other embodiments, the energy source can be replaced by any consumable that can be replenished.

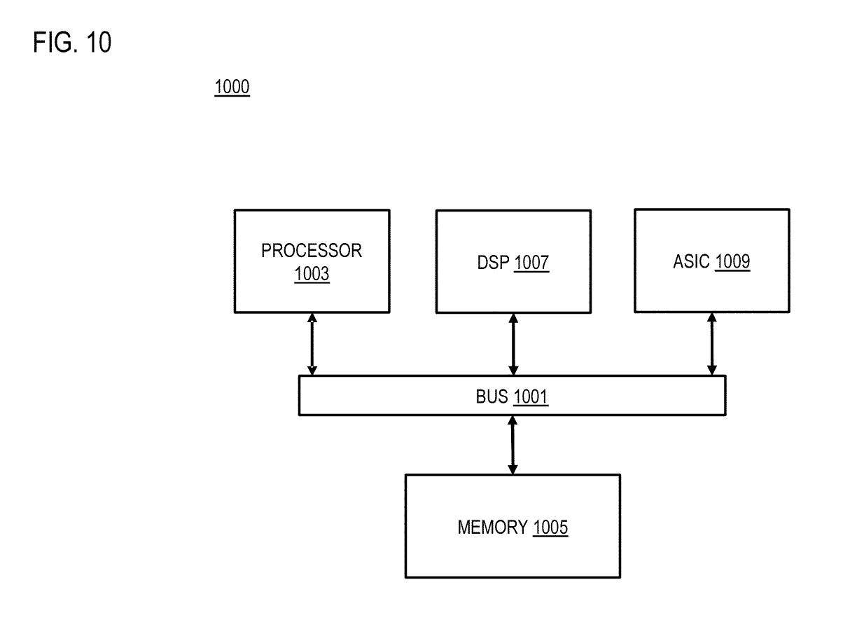

FIG. 4 is a flowchart of a process for providing a time-based representation of an energy level, according to one embodiment. In one embodiment, the energy management module 103, the energy management platform 105, and/or any of the modules 301-307 may perform one or more portions of the process 400 and may be implemented in, for instance, a chip set including a processor and a memory as shown in FIG. 10. As such, the energy management module 103, the energy management platform 105, and/or any of the modules 301-307 can provide means for accomplishing various parts of the process 400. In addition or alternatively, the services platform 117, and/or one or more of the services 119a-119n (also collectively referred to as services 119) may perform any combination of the steps of the process 400 in combination with the energy management module 103 and/or the energy management platform 105, or as standalone components. Although the process 400 is illustrated and described as a sequence of steps, it is contemplated that various embodiments of the process 400 may be performed in any order or combination and need not include all of the illustrated steps.

In step 401, the data module 301 records a usage history, a usage pattern, or combination (e.g., usage data) thereof associated with an operation of a vehicle 101 or a device (e.g., UE 113) by a user. The usage data can be stored in the user database 111. In one embodiment, the usage history can include data records recording when, where, how long, energy consumption, etc. used during an operational instance of the vehicle 101 or UE 113 (e.g., a trip made in the vehicle 101 by the user). Additional contextual parameters (e.g., weather, traffic conditions, road conditions, number of passengers, etc.) can also be collected and analyzed by the data module 301. In one embodiment, a usage pattern refers to detected repeated driving behaviors (e.g., exhibited in the usage data). Examples of such repeated behaviors include but are not limited to: weekday commutes between home and work, weekend trips to a shopping mall, trips to school, etc.

In one embodiment, the data module 301 processes usage data to build data models of the usage history and/or usage patterns for the user. The models can be used for temporal (e.g., daily, weekly, monthly, etc.) or “activity-based” (e.g., commuting, shopping trip, vacation, etc.) breakdowns of the usage data. In other words, the data module 301 can use data models (e.g., statistical models, predictive models, and/or the like) to stratify the usage according to any contextual attribute (e.g., time, activity, weather, location, etc.). In one embodiment, if there are multiple users of a vehicle 101 or UE 113, the data module 301 dynamically select the usage history, the usage pattern, or a combination thereof based on identifying the user that is operating the vehicle 101 or UE 113 from among a plurality of users. In one embodiment, the identifying can be based on automated means (e.g., detecting the user based on the key used to operate a vehicle, detecting unique tags associated with each user such as NFC or RFID tags, etc.), or by manual means (e.g., asking the user log into the vehicle 101 and/or UE 113 or to otherwise identify himself or herself to the system 100).

In step 403, the data module 301 determines a remaining energy level of a vehicle 101 or UE 113. By way of example, the remaining energy level is a fuel level, a battery charge level, or a combination thereof. In one embodiment, the data module 301 can access sensors or other vehicle/device systems (e.g., access vehicle data via an OBD II port or equivalent) to retrieve a current or remaining energy level of the vehicle 101 or UE 113.

In step 405, the prediction module 303 computes a predicted time that the vehicle 101 or UE 113 can be operated based on the remaining energy level. In one embodiment, the prediction module 303 can consider a user's usage data (e.g., data collected in step 401 above), as well as planned trips or planned uses when data on such trips or uses is available (e.g., available from personal information management data such as calendar entries, appointments, invitations, etc.). The predicted time can then be based on, for instance, the usage history, usage pattern, planned use of the vehicle/device, or a combination thereof associated with one or more users of the vehicle 101 and/or UE 113. In other words, based on the previous usage patterns, anticipated events (e.g., anticipated based on the usage models created in step 401, planned uses or actions (e.g., determined from calendar data, user input, and/or the like), the prediction module 303 can predict when the battery, fuel tank, etc. will be empty.

In one embodiment, the prediction module 303 can use any means to compute the predicted time that the vehicle 101 can be operated using the determined remaining energy level. For example, the prediction module 303 can use predictive or statistical models such as but not limited to machine learning models (e.g., neural networks, support vector machines (SVM), decision trees, RandomForest, logistic regression model, etc.). In one embodiment, the prediction module 303 can use supervised machine learning or equivalent to train a machine learning model to compute the predicted times of operation from a remaining energy level.

For example, during training of such a model, the prediction module 303 uses a learner module that feeds feature sets from each individual training data set (e.g., ground truth labeled feature sets that annotate and observed set of remaining energy level related features with a known operating time) into the feature detection model to compute a predicted matching feature using an initial set of model parameters (e.g., an initial set of model weights). The learner module then compares the predicted matching probability and the predicted feature to the ground truth data (e.g., the ground truth annotated feature labels) in the respective training data set. The learner module then computes an accuracy of the predictions for the initial set of model parameters or weights. If the accuracy or level of performance does not meet a threshold or configured level, the learner module incrementally adjusts the model parameters or weights until the model generates predictions at a desired or configured level of accuracy with respect to the ground truth data. This results in producing a “trained” feature prediction model is a classifier with model parameters or weights adjusted to make accurate predictions with respect to predicting operating times of vehicles 101 and/or UEs 113 from remaining energy levels and other related features.

In one embodiment, the predicted time that the vehicle can be operated can further account for an energy reserve level, an energy buffer level, or a combination thereof associated with the user. In one embodiment, the energy reserve represents a user's comfort level with respect to how much energy (e.g., charge or fuel) remains before the user typically replenishes (e.g., recharges or refuels). A collected usage history may indicate, for instance, that a particular user usually recharges or refuels when the remaining energy level reaches 25% of absolute capacity (e.g., battery capacity, fuel tank size, etc.). Accordingly, the prediction module 303 can also make a refueling prediction based the current absolute fuel/charge level and the user's comfort or reserve level (e.g., the battery is 30% full, but the user usually recharges before the battery reaches 25%).

In one embodiment, the prediction module 303 can also account for an additional energy buffer level. This buffer level represents, for instance, an amount of battery capacity that the user and/or or the system 100 would like to consider when computing the predicted operation time to anticipated unexpected or trips or other users. In one embodiment, this buffer level can also be learned from the usage data (e.g., a user typically tops off a battery charge before the weekend in cause the user needs to visit a sick relative or take the kids to a far soccer game). To consider the reserve and/or buffer levels, the prediction module 303 can subtract the reserve and/or buffer levels from the remaining energy level before computing the predicted time that the vehicle 101 or UE 113 can operate using remaining energy level. In one embodiment, the amount of the reserve and/or buffer levels can be contextual and depend on factor such as but not limited to: personal user preferences, a planned journey/commute (e.g., length and duration of the planned trip or use), and/or other risk factors (e.g., probability of traffic congestion, weather conditions such as cold weather that reduce batter capacity, road conditions, accidents, etc.).

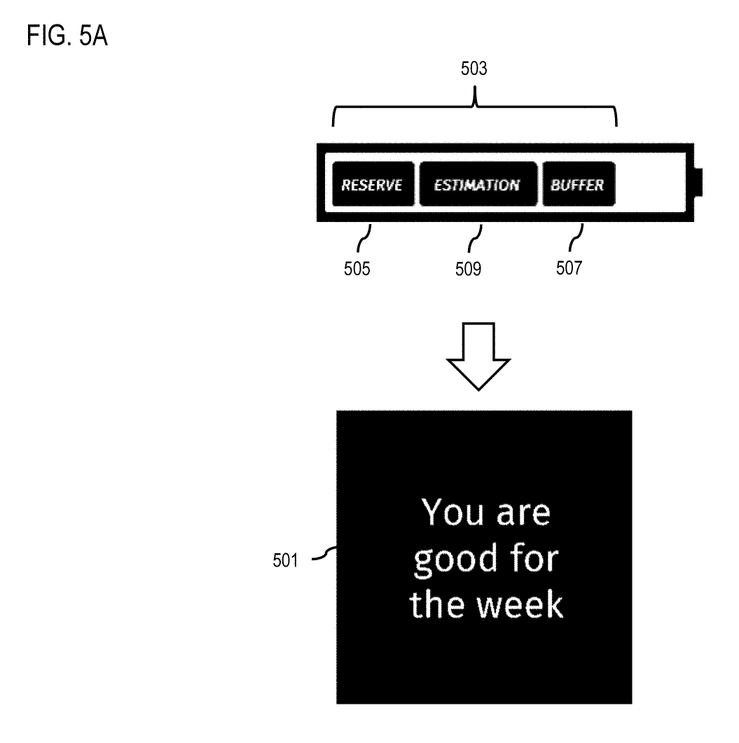

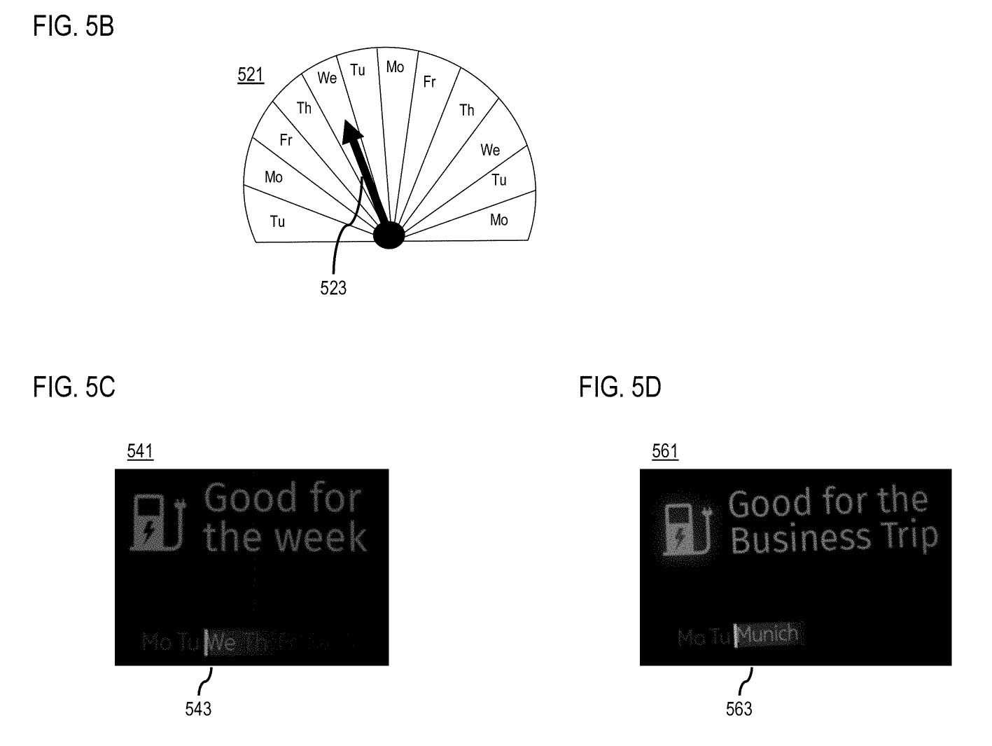

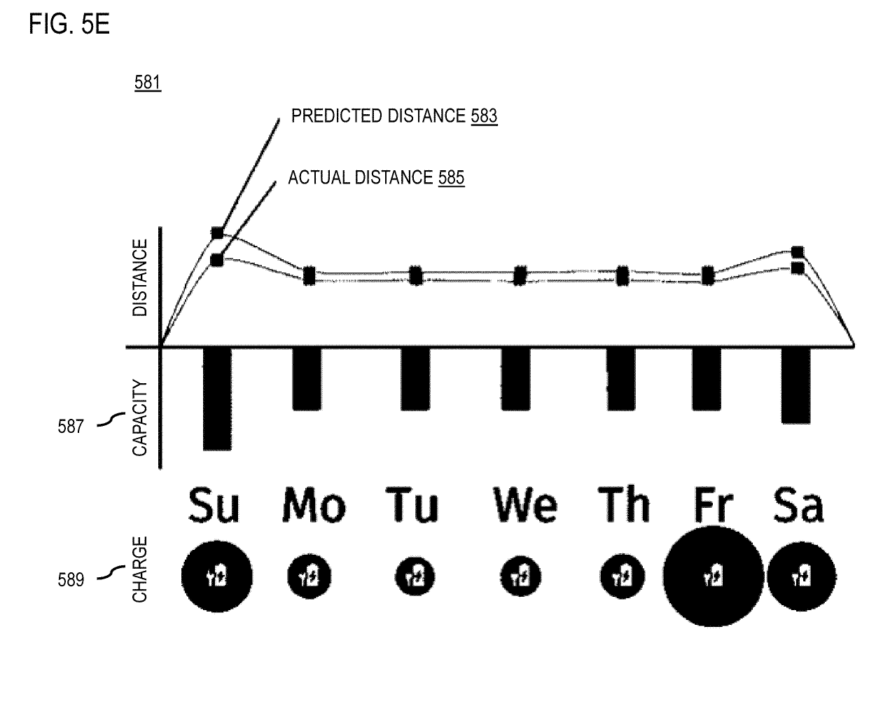

FIG. 5A illustrates an example of generating a time-based representation 501 of a remaining energy level 503 of a vehicle 101 which accounts for a reserve level 505 and a buffer level 507, according to one embodiment. As described in the embodiments above, the prediction module 303 partitions the remaining battery level 503 to set aside both the reserve level 505 and buffer level 507 to leave an estimation portion 509 of the remaining energy level 503. The prediction module 303 then uses only the estimation portion 509 to compute a predicted time that the vehicle 101 can operate based on user usage data, anticipated trips/uses, planned trips/uses, and/or the like indicated in the time-based representation 501. In other words, the vehicle 101 would only be expected to use up the energy level of the estimation portion 509 in the predicted time indicated by the time-based representation 501 (i.e., one week), leaving the energy capacity of the reserve level 505 and the buffer level 507 as a margin of safety.

In one embodiment, the prediction module 303 can also account for multiple users of the same vehicle 101 or UE 113. For example, when a vehicle 101 is shared across multiple users (e.g., family members, friends, fleet vehicles, etc.), the prediction module 305 can determine and evaluate factors including, but not limited to: (1) who will be the next person using the vehicle 101 or UE 113; (2) when and how long the next person will be using the vehicle 101 or UE 113; (3) what distance and energy level is needed for the next person; etc. In one embodiment, in case the next journey or use of the vehicle 101 or UE 113 cannot be accomplished given the remaining energy level, the prediction module 303 can interact with the output module 307 to generate an alert so that the user is informed ahead of time about the risk of not being able to complete the user's journey with the currently remaining energy level. In one embodiment, the prediction module 303 can also suggest alternative solutions as follows: “User A parked the car in front of the house but the remaining 15% of charge won't allow you to pick up your friend at the airport tomorrow, we recommend that you do one of the following: go and charge the car now if possible, book an alternative vehicle to go there tomorrow, and ask your friend to take the train for 1.5 hours so you can pick him up at the nearby train station.”

In another embodiment, the prediction module 303 can interact with the services platform 117 and/or any of the services 119 to trigger the computation of predicted operating times based on remaining energy levels. A user can link any of the services 119 to the energy management module 103 and/or platform 103, so that if the user engages in any service activity includes use of the vehicle 101, the energy prediction module 303 can determine whether the service activity can be supported using the remaining energy levels. In one use case, a linked service 119 can be an online booking service (e.g., for booking concert tickets, trips, etc.) so that the user would be informed at the booking time about the consequences of a purchase (e.g., if the booked event is expected to happen within a current charging/fueling period). For example, either the service 119 itself (e.g., via an application programming interface or equivalent to the energy management module 103 or platform 105) or the energy management module 103/platform 105 can present a message indicating the impact the purchase and provide options for responding (e.g., “buying a ticket to this concert 80 km way means you will likely have to recharge your car on Wednesday before going to this event instead of Saturday, is that fine?”). A user can find it advantageous to know this information before making the purchase, rather than discovering it once the purchase or other service activity has been completed.

In embodiments where the vehicle 101 or UE 113 is equipped with multiple different types of energy sources (e.g., a hybrid vehicle with rechargeable batteries as well as a fuel tank), the prediction module 303 can make predictions for each energy source individually or in combination. For example, for hybrid vehicles, the prediction module 303 can compute respective predicted operating times for the battery portion and the fuel tank individually (e.g., predict that the remaining battery level can last two days under normal use, and the fuel level can last 4 days under normal use). Alternatively, the prediction module 303 can compute a combined prediction of both the battery and fuel levels (e.g., the hybrid vehicle can operate for 5 days under normal use before either having to recharge or refuel). In addition, recommended times and/or locations for replenishing each of the different energy types (e.g., recommended charging times/locations for the batteries, and/or recommended fueling locations for the fuel tank) can also be presented individually or in combination.

Returning to FIG. 4, in step 407, after computing the predicted time, the output module 307 presents a user interface depicting a representation of the predicted time as an indicator of an energy status of the vehicle. In other words, in place of or in addition to a traditional energy level gauge (e.g., battery or fuel level indicator), the output module 307 can display a representation (e.g., a visual representation) of the predicted operation time determined according to the embodiments described above. As described above, in addition to the examples of time-based representations described above, it is contemplated that the output module 307 can render any other type of representation. For example, in one embodiment, the representation of the predicted time can be as simple as including a message indicating that the remaining energy level is enough to operate the vehicle for the predicted time (e.g., good until next Wednesday). In another embodiment, the representation of the predicted time can be a visualization of a day of the week, a time of the day, or a combination thereof on which the predicted operating time is computed to end. The time can be provided with respect to an explicit day as illustrated above, or with respect to any other time reference that may be relevant to a user (e.g., good until Joe's birthday, until you start your vacation, until your next appointment, etc.). In one embodiment, the output module 307 can query the user's calendar data or other equivalent databases to determine relevant time references to present.

FIG. 5B illustrates a time-based representation 521 that is specialized for vehicles 101 used only for weekday commutes. Accordingly, the gauge rendered in the time-based representation 521 is marked with only weekdays (e.g., Monday-Friday). The current day (e.g., Monday) is displayed on the lower right side with the gauge sweeping counter clockwise to day farther into the future (e.g., up to Tuesday two weeks later). In this example, the prediction module 303 has computed a predicted time to deplete the remaining energy level at approximately 1.5 weeks in the future (the second Wednesday after the current date) as indicated by a rendered arrow 523. In this way, the user can quickly and intuitively see how long the current energy level will last and when the user will need to recharge or refuel. In one embodiment, the time-based representation 521 can be an interactive user interface or user interface element, that enables a user to request more information or have access to additional options by selecting different elements of the time-based representation (e.g., selecting a day to see more information such as predicted remaining charge, predicted range, etc.).

FIGS. 5C and 5D illustrate alternate time-based representations 541 and 561 respectively of the same remaining energy level of the example of FIG. 5B. For example, the time-based representation 541 of FIG. 5C presents a plain language message that indicates the remaining energy level is “Good for the week” meaning that the prediction module 303 predicts that the remaining energy level will last for at least a week (e.g., in this case 1.5 weeks as described the example of FIG. 5B), and also provides a visual indicator 543 that recharging or refueling would be needed by next Wednesday. In the example of FIG. 561 of FIG. 5C, the prediction module 303 processes the user's calendar data and determines that the user will be taking a business trip over the next week and computes that the remaining energy level of the vehicle 101 should be enough to cover the business trip. As a result, the time-based representation 561 provides a plain language message that the remaining energy level would be “Good for the business trip” and also provides a visual indicator 563 that the vehicle 101 would need to be recharged or refueled when the user arrives next Wednesday in Munich for the schedule business trip.

In one embodiment, the output module 307 presents, in the user interface, a representation of a predicted evolution of the remaining energy level over the predicted time (e.g., computed by the prediction module 303). FIG. 5E illustrates an example user interface (UI) 581 depicting an evolution of the remaining energy level over a one-week time frame from Sunday to Saturday. More specifically, the UI 581 depicts a graph of predicted distance 583 and actual distance 585 traveled by the vehicle 101 for each day over the predicted time frame along with the predicted energy capacity expected to be used each day. The UI 587 also depicts representations of the recommended charge 589 for each day with the size of the charge icon representing recommended recharging duration. In one embodiment, because both the predicted and actual uses are tracked, if a user does not use the vehicle 101 to draft as much as predicted, then the available duration (e.g., predicted time to operate on remaining energy level) can also increase correspondingly. Additional description of the process for recommending when and where to recharge or refuel is provided below.

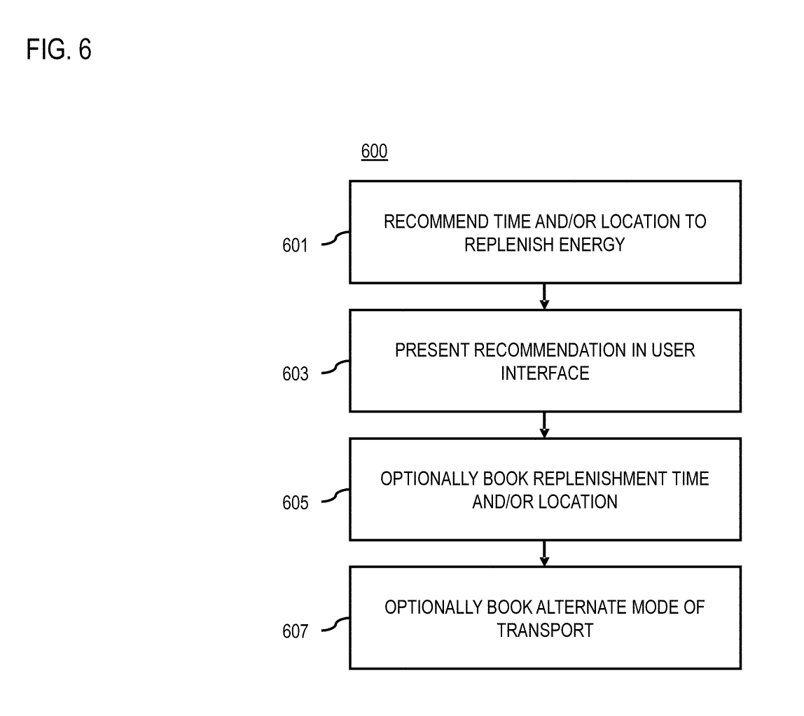

FIG. 6 is a flowchart of a process for recommending energy replenishment parameters, according to one embodiment. In one embodiment, the energy management module 103, the energy management platform 105, and/or any of the modules 301-307 may perform one or more portions of the process 600 and may be implemented in, for instance, a chip set including a processor and a memory as shown in FIG. 10. As such, the energy management module 103, the energy management platform 105, and/or any of the modules 301-307 can provide means for accomplishing various parts of the process 600. In addition or alternatively, the services platform 117, and/or one or more of the services 119 may perform any combination of the steps of the process 600 in combination with the energy management module 103 and/or the energy management platform 105, or as standalone components. Although the process 600 is illustrated and described as a sequence of steps, it is contemplated that various embodiments of the process 600 may be performed in any order or combination and need not include all of the illustrated steps.

In one embodiment, the process 600 can be performed in combination with the process 400 of FIG. 4 that computes a predicted time that a vehicle 101 or UE 113 can operate using a determined remaining energy level (e.g., a current charge or fuel level). In step 601, the recommendation module 305 recommends a time, a location, or a combination thereof to replenish the remaining energy level based on the predicted time, a predicted use of the vehicle, a planned use of the vehicle, or a combination thereof. In one embodiment, other user devices (e.g., a phone) could be used to further learn from users, their habits, patterns, etc. When users consent to share their location, location information can be used to better predict the next possible use of the vehicle 101 or UE 113.

In one embodiment, the recommendation module 305 can use the same or similar predictive or statistical models as described above with respect to the process 400 of FIG. 4. For example, the trained prediction models can be used in combination with the digital map data of the geographic database to identify energy station facilities 121 (e.g., recharging facilities, refueling facilities, etc.) that can be recommended to the user. In one embodiment, the recommendation module 305 recommends when and where to refuel/recharge (e.g., replenish energy reserves) based on the predicted evolution of energy levels (e.g., predicted according to the embodiments of the process 400 of FIG. 4), and the proximity of such fuel/charge stations (e.g., energy station facilities 121) along the predicted or planned routes.

In one embodiment, the recommending of the time, the location, or a combination thereof to replenish the remaining energy includes recommending an energy replenishing level. for example, a user may not be able to fully charge the batteries of an electric vehicle any number of reasons including but not limited to: not enough time to fully charge, other users need the same charging spot, etc. Accordingly, the recommendation module 305 can recommend a replenishment level (e.g., a charge level) to reach a target predicted time of operation. For example, the recommendation can recommend that the user “Charge for 30 mins and you will be good for the next two days.” In another embodiment, the output module 307 can also dynamically show while charging or refueling a number of days to next refill. This time-based indicator can be presented alone or in combination with a traditional percent charge level. For example, seeing that the car is 40% full (i.e., a traditional energy level display) may not be self-explaining for a user but seeing that 40% full should be enough for regular drives until next Monday or for the four days tells the user that it may be enough as the user will be able to recharge next weekend.

In one embodiment, the recommended time, the recommended location, or a combination thereof is further based on a busy state of the user. In other words, the recommendation module 305 can try to evaluate how busy the user is at a given time and location in order to better understand whether this user could go and replenish the energy levels of the vehicle 101 or UE 113 (e.g., plug the vehicle 101 into a charging station if needed). For example, if there is a charging station in the user's office building, the recommendation module 305 can detect that the user is “busy” as indicated in the user's calendar data during most of the day but the user can still actually go and plug the car to charge if needed since the charging station is located in the same building (e.g., as indicated by the digital map data of the geographic database 109). The recommendation module 305 can also lead to combining activities in the user's calendar. For example, the recommendation module 305 can recommend that the user plug in his vehicle 101 to recharge when the user is scheduled to have coffee with a friend nearby the charging station, but will not make the same recommendation during the night while the user is sleeping.

In one embodiment, the recommended time, the recommended location, or a combination thereof is further based on an energy replenishment cost. In some countries or jurisdictions, energy costs (e.g., electricity costs for recharging) can vary between different times of the day (e.g., between day versus night, with night time usually being cheaper because of less demand). In one embodiment, the recommendation module 305 can be configured to be price sensitive by the user so that the recommendation module 305 to optimize charging costs by recommending recharging or refueling locations and/or times when energy costs are less expensive.

In one embodiment, the recommended time, the recommended location, or a combination thereof is further based on an energy replenishment mode of the vehicle, an energy replenishment connector of the vehicle, or a combination thereof. For example, the recommendation module 305 can query the digital map data of the geographic database 109 to determine nearby charging or refueling stations that have the request charging modes (e.g., fast charging) with the charging connectors that are compatible with the user's vehicle 101 or UE 113.

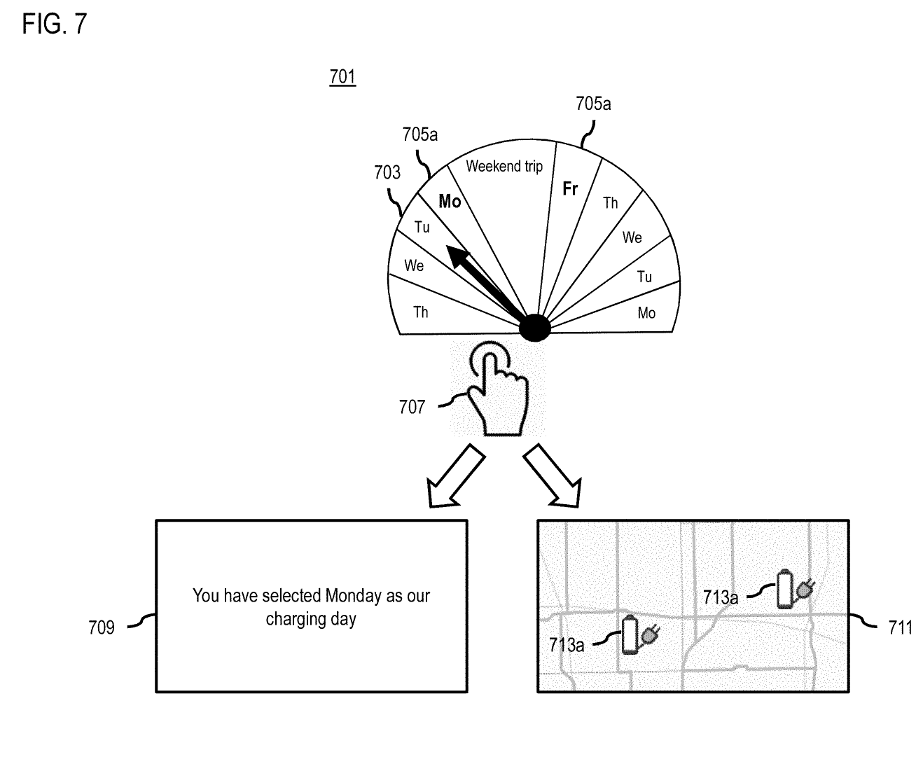

In step 603, the output module 307 presents the recommendations in a user interface (e.g., a user interface including the time-based representations of energy levels as generated according to the process 400 of FIG. 4). The output module 307, for instance, can integrate the recommendations into the time-based presentation as shown in the time-based representation 701 of FIG. 7. In this example, the time-based representation 701 indicates that the vehicle 101 has enough remaining energy level to operate (e.g., under a user normal usage behavior or patterns) until day 703 (e.g., a Tuesday). However, based on an analysis of historical usage data for the user, the recommendation module 305 determines Monday and Friday is not usually too stressful for the user, but the other days are usually busy days. Accordingly, the recommendation module 305 recommends that the user recharge/refuel on Monday or Friday. Based on this recommendation, the output module 307 can highlight day 705a (e.g., Monday) and day 705b (e.g., Friday) to indicate that they are the recommended recharging/refueling dates. In one embodiment, the time-based representation 701 is interactive and allows a user to perform an interaction 707, for instance, to select from among the recommended charging days or any other presented days. For example, if the user selects the highlighted day 705a (e.g. Monday), the output module 307 can present a message 709 to confirm the selected charging day (e.g., “You have selected Monday as your charging day”). In addition or alternatively, the interaction 707 can trigger a presentation of a map 711 of recommended charging stations 713a and 713b for the selected day.

In step 605, the recommendation module 305 optionally books a replenishment time and/or location, for instance, by transmitting a reservation request to book a slot at the recommended location to replenish the remaining energy level of the vehicle at the recommended time. In addition, the recommendation module 305 can automatically update the user's calendar data based on the reservation request by, for instance, making an entry in the user's calendar to make sure the user remembers and sees the entry. The recommendation module 305 can create several entries in the calendar data if several recharging/refueling options were initially recommended. In one embodiment, the replenishment time (e.g., recharging or refueling time) can be with respect to reaching a full recharge/refueling or to reach a desired day (e.g., charge 40 mins to reach the weekend).

In step 607, the recommendation module 305 optionally initiates a request to book an alternate mode of transportation (e.g., shared vehicle, public transport, a shared ride sharing service, etc.) for use while the remaining energy level of the vehicle is replenished at the recommended location. In one embodiment, the reservation request of step 605 can include this additional request for the alternate mode of transportation. For example, the recommendation module 305 can suggest that the user stop or remain at a charging location (e.g., when recharging is expected to take more than a threshold amount of time), and use a shared car, ride sharing service, public transport, or other alternative modes of transportation to continue on the user's trip while the vehicle 101 reaches a desired energy level. For example, the recommendation module 305 can interface the geographic database 109 and/or the services platform 117 or any of the services 119 to determine whether there are any alternate modes of transportation near a recommended recharging/refueling location or otherwise suitable to continue the user's trip.

If the user decides to proceed with recharging/refueling, a smartphone or other user device can get notifications when a defined charging state is reached. For example, the user can request the energy management module 103 send the user a notification when the charge level is enough for specified period of time. For example, if the user requests a notification for when the energy level is enough for a week, the energy management module 103 can respond by confirming the notification request and/or presenting an estimated time to reach the request energy level (e.g., “Charge for week should take approximately 1.5 hours”).

In one embodiment, batteries for electric vehicles 101 have optimal charging cycles that can be considered for optimal use and maintenance, particularly in light of the high costs of such batteries. Accordingly, the recommendation module 305 can consider these optimal charging cycles when recommending charging times, locations, and/or charge levels. For example, if it is recommended that the battery level should ideally never fall below a minimum percentage, then the recommendation module 305 should take this into account when recommending when and where to charge. If the battery manufacturer recommends avoiding some specific battery states, this should also be taken into account when recommending charging options. In one embodiment, charging profiles should also be considered.

The following describes example use cases for providing a time-based representation of energy levels for an electric vehicle and a combustion engine vehicle respectively. For example, an electric vehicle example can include a user who goes to work 20 km by car every day (i.e., 40 km every day round trip). Based on analysis of usage data, the system 100 determines that the user likes to recharge the vehicle batteries with the charging level is around 30%, which means quite often due to the limited range of the vehicle's battery. The user also likes to recharge at a charging station which is on a street near the user's office. The problem is that the station is not always free, so the user parks nearby and waits for a notification when the station is available. The user then goes to move his car, ideally at lunch time. As this process is really not convenient for the user, knowing how many days the current charge will last can be important so the user does not need to perform this routine to charge his car when it is not necessary (e.g., when the system 100 predicts that the remaining charge is sufficient to operate the vehicle until a future date) or if the context is not good (e.g., bad weather).

With respect to a use case combustion engine use case, a user drives a gasoline-power vehicle 20 km to work every day (e.g., 40 km round trip). The user likes to refill when the vehicle's tank is between 20% and 30%. The user also likes to refill after work and gas stations operated by a particular company. Also Tuesday and Thursday are the best days for refueling due to a less stressful agenda on those days. Based on this usage data and preferences, the system 100 computed time-based representations of the user's remaining fuel and make recommendations of when and where to refuel according to the embodiments described herein.

As noted above, the embodiments for providing a time-based representation of remaining energy levels described herein are particularly applicable to electric vehicles due to: (1) the relatively long charging times for these vehicles; (2) the range anxiety some drivers face; and (3) relatively low number of charging stations compared to fuel stations. For at least those reasons, the system 100 faces several technical challenges and provides solutions. For example, with respect to relatively long electric vehicle charging times, the system 100 optimizes the charging times by recommending charging times that are sufficient to cover a user's normal vehicle usage but are not more than what is needed to minimize charging times. With respect to range anxiety, the system 100 surfaces how many days the user can drive for using a remaining charge level. Providing days can reduce range anxiety because it is a more intuitive representation that can be more easily understood than an abstract charge level. As discussed above, providing days is only one example of an intuitive representation. The system 100 can use any time reference relevant to the user to indicate how long a car can be used on the remaining charge or fuel level (e.g., until Joe's birthday, until you start your vacation, until your next appointment, etc.). Finally, with respect to the relatively low number of charging stations compared to fuel stations, the system 100 can recommend and automatically book charging stations on a commute or journey at a suitable time and for an optimized during that can achieve a desired number of days of operation.

Returning to FIG. 1, as shown, the system 100 includes the energy management module 103 and/or the energy management platform 105 for providing a time-based representation of a charge or fuel level according the various embodiments described herein. In one embodiment, the energy management module 103 can be included as a component of a vehicle 101 (e.g., an electric vehicle or combustion engine vehicle). In one embodiment, the energy management module 103 can include an in-vehicle machine learning classifier to compute predicted times that a vehicle 101 or UE 113 can be operated using a known remaining energy level, according to the various embodiments described herein. In one embodiment, the machine learning classifier can include one or more feature detection models such as, but not limited to, neural networks, SVMs, decision trees, etc.

In one embodiment, the energy management module 103 and/or the energy management platform 105 also have connectivity or access to the geographic database 109 which stores representations of mapped geographic features to facilitate autonomous driving and/or other mapping/navigation-related applications or services. The geographic database 109 can also store specialized predictive models and/or model weights in conjunction with map data according to the various embodiments described herein.

In one embodiment, the energy management module 103 and/or the energy management platform 105 have connectivity over a communication network 107 to the services platform 117 that provides one or more services 119. By way of example, the services 119 may be third party services and include calendar services, mapping services, navigation services, travel planning services, notification services, social networking services, content (e.g., audio, video, images, etc.) provisioning services, application services, storage services, contextual information determination services, location-based services, information-based services (e.g., weather, news, etc.), etc.

In one embodiment, the energy management module 103 and/or the energy management platform 105 may be platforms with multiple interconnected components. The energy management module 103 and/or the energy management platform 105 may include multiple servers, intelligent networking devices, computing devices, components and corresponding software for providing time-based representations of energy levels. In addition, it is noted that the energy management module 103 and/or the energy management platform 105 may be a separate entity of the system 100, a part of the one or more services 119, a part of the services platform 117, or included within the UE 113 and/or vehicle 101.

In one embodiment, content providers 123a-123m (collectively referred to as content providers 123) may provide content or data (e.g., including geographic data, parametric representations of mapped features, etc.) to the geographic database 109, the energy management module 103, the energy management platform 105, the services platform 117, the services 119, the UE 113, the vehicle 101, and/or an application 115 executing on the UE 113. The content provided may be any type of content, such as map content, textual content, audio content, video content, image content, etc. In one embodiment, the content providers 123 may provide content that may aid in the detecting and classifying of lane lines and/or other features in image data, and estimating the quality of the detected features. In one embodiment, the content providers 123 may also store content associated with the geographic database 109, energy management module 103, energy management module 105, services platform 117, services 119, UE 113, and/or vehicle 101. In another embodiment, the content providers 123 may manage access to a central repository of data, and offer a consistent, standard interface to data, such as a repository of the geographic database 109.

In one embodiment, the UE 113 and/or vehicle 101 may execute a software application 115 to collect, encode, and/or decode vehicle/device usage data for providing a time-based representation of energy levels according the embodiments described herein. By way of example, the application 115 may also be any type of application that is executable on the UE 113 and/or vehicle 101, such as autonomous driving applications, mapping applications, location-based service applications, navigation applications, content provisioning services, camera/imaging application, media player applications, social networking applications, calendar applications, and the like. In one embodiment, the application 115 may act as a client for the energy management module 103 and/or energy management platform 105 and perform one or more functions associated with providing time-based representations of energy levels.

By way of example, the UE 113 is any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 113 can support any type of interface to the user (such as “wearable” circuitry, etc.). In one embodiment, the UE 113 may be associated with the vehicle 101 or be a component part of the vehicle 101.

In one embodiment, the UE 113 and/or vehicle 101 are configured with various sensors for generating or collecting environmental sensor data (e.g., for recording vehicle usage habits, patterns, etc.), related geographic data, etc. including but not limited to, optical, radar, ultrasonic, LiDAR, etc. sensors. In one embodiment, the sensed data represent sensor data associated with a geographic location or coordinates at which the sensor data was collected. By way of example, the sensors may include a global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, switch sensors for determining whether one or more vehicle switches are engaged, and the like.

Other examples of sensors of the UE 113 and/or vehicle 101 may include light sensors, orientation sensors augmented with height sensors and acceleration sensor (e.g., an accelerometer can measure acceleration and can be used to determine orientation of the vehicle), tilt sensors to detect the degree of incline or decline of the vehicle along a path of travel, moisture sensors, pressure sensors, etc. In a further example embodiment, sensors about the perimeter of the UE 113 and/or vehicle 101 may detect the relative distance of the vehicle from a lane or roadway, the presence of other vehicles, pedestrians, traffic lights, potholes and any other objects, or a combination thereof. In one scenario, the sensors may detect weather data, traffic information, or a combination thereof. In one embodiment, the UE 113 and/or vehicle 101 may include GPS or other satellite-based receivers to obtain geographic coordinates from satellites for determining current location and time. Further, the location can be determined by visual odometry, triangulation systems such as A-GPS, Cell of Origin, or other location extrapolation technologies. In yet another embodiment, the sensors can determine the status of various control elements of the car, such as activation of wipers, use of a brake pedal, use of an acceleration pedal, angle of the steering wheel, activation of hazard lights, activation of head lights, etc.

In one embodiment, the communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the energy management module 103, energy management platform 105, services platform 117, services 119, UE 113, vehicle 101, and/or content providers 123 communicate with each other and other components of the system 100 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

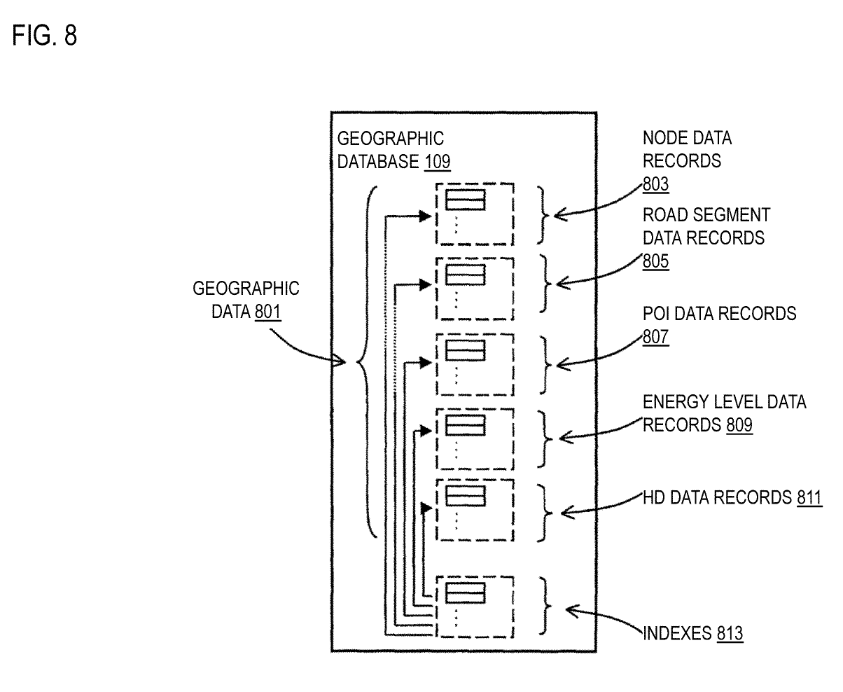

FIG. 8 is a diagram of a geographic database 109, according to one embodiment. In one embodiment, the geographic database 109 includes geographic data 801 used for (or configured to be compiled to be used for) providing time-based representations of energy levels. In one embodiment, the geographic database 109 include high resolution or high definition (HD) mapping data that provide centimeter-level or better accuracy of map features. For example, the geographic database 109 can be based on Light Detection and Ranging (LiDAR) or equivalent technology to collect billions of 3D points and model road surfaces and other map features down to the number lanes and their widths. In one embodiment, the HD mapping data (e.g., HD data records 811) capture and store details such as the slope and curvature of the road, lane markings, roadside objects such as sign posts, including what the signage denotes. By way of example, the HD mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 109.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 109 follows certain conventions. For example, links do not cross themselves and do not cross each other except at a node. Also, there are no duplicated shape points, nodes, or links. Two links that connect each other have a common node. In the geographic database 109, overlapping geographic features are represented by overlapping polygons. When polygons overlap, the boundary of one polygon crosses the boundary of the other polygon. In the geographic database 109, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

In one embodiment, the geographic database 109 is stored as a hierarchical or multi-level tile-based projection or structure. More specifically, in one embodiment, the geographic database 109 may be defined according to a normalized Mercator projection. Other projections may be used. By way of example, the map tile grid of a Mercator or similar projection is a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom or resolution level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grid 10. Because of the numbering system, the exact position of any tile in any level of the map tile grid or projection may be uniquely determined from the tile ID.

In one embodiment, the system 100 may identify a tile by a quadkey determined based on the tile ID of a tile of the map tile grid. The quadkey, for example, is a one-dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid in order to maintain a constant length for the one-dimensional array of the quadkey. In another example, the length of the one-dimensional array of the quadkey may indicate the corresponding level within the map tile grid 10. In one embodiment, the quadkey is an example of the hash or encoding scheme of the respective geographical coordinates of a geographical data point that can be used to identify a tile in which the geographical data point is located.

As shown, the geographic database 109 includes node data records 803, road segment or link data records 805, POI data records 807, energy level records 809, HD mapping data records 811, and indexes 813, for example. More, fewer or different data records can be provided. In one embodiment, additional data records (not shown) can include cartographic (“carto”) data records, routing data, and maneuver data. In one embodiment, the indexes 813 may improve the speed of data retrieval operations in the geographic database 109. In one embodiment, the indexes 813 may be used to quickly locate data without having to search every row in the geographic database 109 every time it is accessed. For example, in one embodiment, the indexes 813 can be a spatial index of the polygon points associated with stored feature polygons.

In exemplary embodiments, the road segment data records 805 are links or segments representing roads, streets, or paths, as can be used in the calculated route or recorded route information for determination of one or more personalized routes. The node data records 803 are end points corresponding to the respective links or segments of the road segment data records 805. The road link data records 805 and the node data records 803 represent a road network, such as used by vehicles, cars, and/or other entities. Alternatively, the geographic database 109 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 109 can include data about the POIs and their respective locations in the POI data records 807. The geographic database 109 can also include data about places, such as cities, towns, or other communities, and other geographic features, such as bodies of water, mountain ranges, etc. Such place or feature data can be part of the POI data records 807 or can be associated with POIs or POI data records 807 (such as a data point used for displaying or representing a position of a city).

In one embodiment, the geographic database 109 can also include energy level data records 809 including, for instance, training data, usage data, predictive models, time-based representations, and/or any other data generated or used by the system 100 according to the various embodiments described herein. By way of example, the energy level data records 809 can be associated with one or more of the node records 803, road segment records 805, and/or POI data records 807. In this way, the records 809 can also be associated with or used to classify the characteristics or metadata of the corresponding records 803, 805, and/or 807.

In one embodiment, as discussed above, the HD mapping data records 811 model road surfaces and other map features to centimeter-level or better accuracy. The HD mapping data records 811 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the HD mapping data records 811 are divided into spatial partitions of varying sizes to provide HD mapping data to vehicles 101 and other end user devices with near real-time speed without overloading the available resources of the vehicles 101 and/or devices (e.g., computational, memory, bandwidth, etc. resources).

In one embodiment, the HD mapping data records 811 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 811.

In one embodiment, the HD mapping data records 811 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 109 can be maintained by the content provider 123 in association with the services platform 117 (e.g., a map developer). The map developer can collect geographic data to generate and enhance the geographic database 109. There can be different ways used by the map developer to collect data. These ways can include obtaining data from other sources, such as municipalities or respective geographic authorities. In addition, the map developer can employ field personnel to travel by vehicle (e.g., vehicle 101 and/or UE 113) along roads throughout the geographic region to observe features and/or record information about them, for example. Also, remote sensing, such as aerial or satellite photography, can be used.

The geographic database 109 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (P SF)) to organize and/or configure the data for performing navigation-related functions and/or services, such as route calculation, route guidance, map display, speed calculation, distance and travel time functions, and other functions, by a navigation device, such as by a vehicle 101 or UE 113. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing time-based representation of energy levels may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

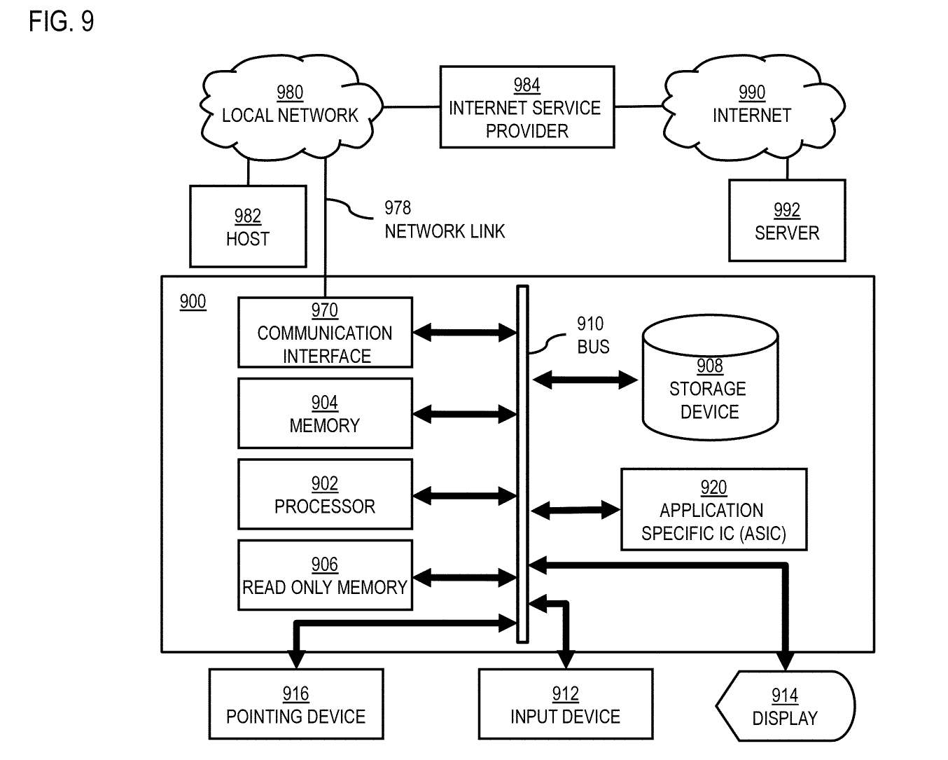

FIG. 9 illustrates a computer system 900 upon which an embodiment of the invention may be implemented. Computer system 900 is programmed (e.g., via computer program code or instructions) to provide time-based representation of energy levels as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to providing time-based representation of energy levels. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for providing time-based representation of energy levels. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing time-based representation of energy levels, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 107 for providing time-based representation of energy levels.

The term computer-readable medium is used herein to refer to any medium that participates in providing information to processor 902, including instructions for execution. Such a medium may take many forms, including, but not limited to, non-volatile media, volatile media and transmission media. Non-volatile media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 10 illustrates a chip set 1000 upon which an embodiment of the invention may be implemented. Chip set 1000 is programmed to provide time-based representation of energy levels as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide time-based representation of energy levels. The memory 1005 also stores the data associated with or generated by the execution of the inventive steps.

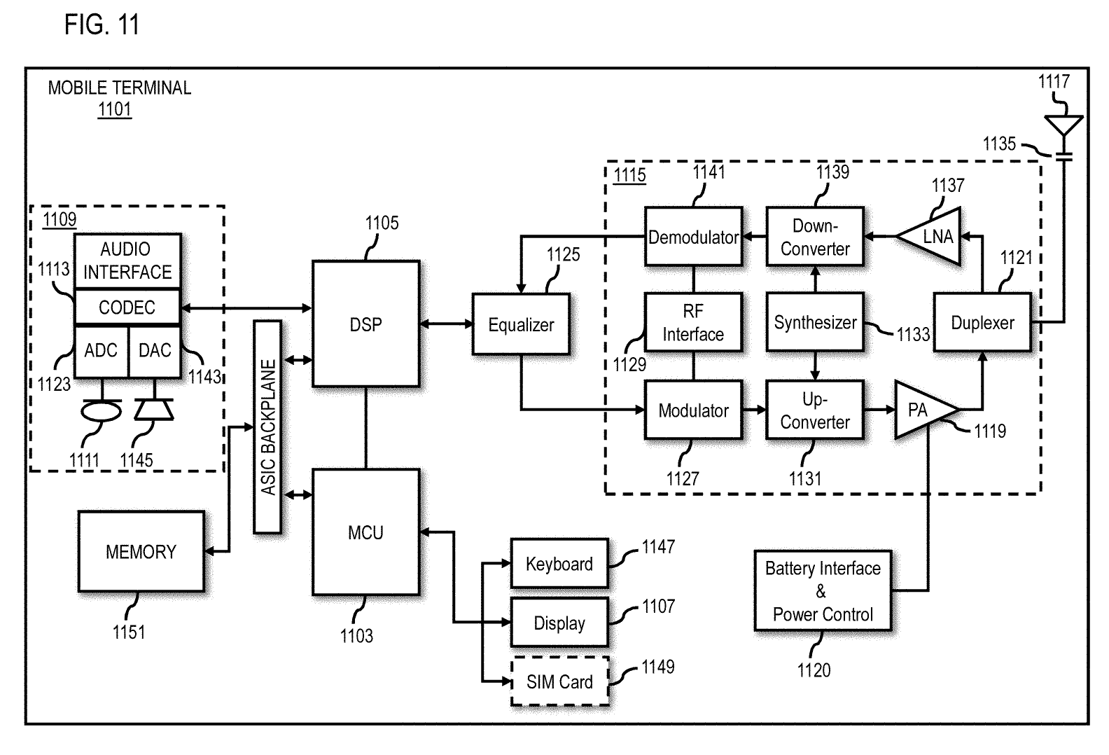

FIG. 11 is a diagram of exemplary components of a terminal or device 1101 (e.g., a component of the vehicle 101, UE 113, etc.) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile station functions that offer automatic contact matching. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile station 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile station 1101 to provide time-based representation of energy levels. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the station. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile station 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1151 may be, but not limited to, a single memory, CD, DVD, ROM, RAM, EEPROM, optical storage, or any other non-volatile or non-transitory storage medium capable of storing digital data.

An optionally incorporated SIM card 1149 carries, for instance, important information, such as the cellular phone number, the carrier supplying service, subscription details, and security information. The SIM card 1149 serves primarily to identify the mobile station 1101 on a radio network. The card 1149 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-implemented method comprising:
determining a remaining energy level of a vehicle;
computing a predicted time that the vehicle can be operated based on the remaining energy level; and
presenting a user interface depicting a representation of the predicted time as an indicator of an energy status of the vehicle.

2. The method of claim 1, further comprising:
recommending a time, a location, or a combination thereof to replenish the remaining energy level based on the predicted time, a predicted use of the vehicle, or a combination thereof.

3. The method of claim 2, wherein the predicted time, the predicted use, or a combination thereof is based on a usage history, a usage pattern, a planned use of the vehicle, or a combination thereof associated with a user of the vehicle.

4. The method of claim 3, further comprising:
dynamically selecting the usage history, the usage pattern, the planned use of the vehicle, or a combination thereof based on identifying the user that is operating the vehicle from among a plurality of users.

5. The method of claim 3, wherein the representation of the predicted time includes a message indicating that the remaining energy level is enough to operate the vehicle for the predicted time, the predicted use, or a combination thereof.

6. The method of claim 3, wherein the representation of the predicted time is a visualization of a day of the week, a time of the day, or a combination thereof on which the predicted time is computed to end.

7. The method of claim 3, wherein the predicted time that the vehicle can be operated, the recommended time or the recommended location to replenish the remaining energy level, or a combination thereof further accounts for an energy reserve level, an energy buffer level, or a combination thereof associated with the user.

8. The method of claim 2, wherein the recommending of the time, the location, or a combination thereof to replenish the remaining energy includes recommending an energy replenishing level.

9. The method of claim 1, further comprising:
presenting, in the user interface, a representation of a predicted evolution of the remaining energy level over the predicted time.

10. The method of claim 1, wherein the remaining energy level is a fuel level, a battery charge level, or a combination thereof.

11. An apparatus comprising:
at least one processor; and
at least one memory including computer program code for one or more programs, the at least one memory and the computer program code configured to, with the at least one processor, cause the apparatus to perform at least the following,
determine a remaining energy level of a device;
compute a predicted time that the device can be operated based on the remaining energy level; and
present a user interface depicting a representation of the predicted time as an indicator of an energy status of the device.

12. The apparatus of claim 11, wherein the apparatus is further caused to:
recommend a time, a location, or a combination thereof to replenish the remaining energy level based on the predicted time, a predicted use of the device, or a combination thereof.

13. The apparatus of claim 12, wherein the recommended time, the recommended location, or a combination thereof is further based on a busy state of the user.

14. The apparatus of claim 12, the recommended time, the recommended location, or a combination thereof is further based on an energy replenishment cost.

15. The method of claim 12, wherein the recommending of the time, the location, or a combination thereof to replenish the remaining energy includes recommending an energy replenishing level.

16. A non-transitory computer-readable storage medium carrying one or more sequences of one or more instructions which, when executed by one or more processors, cause an apparatus to perform:
recording a usage history, a usage pattern, or combination thereof associated with an operation of a vehicle by a user;
generating a representation of a remaining energy level of the vehicle, wherein the representation indicates a predicted time that the vehicle can be operated using the remaining energy level; and
presenting a user interface depicting the representation as an indicator of an energy status of the vehicle.

17. The non-transitory computer-readable storage medium of claim 16, wherein the apparatus is caused to further perform:
recommending a time, a location, or a combination thereof to replenish the remaining energy level based on the predicted time, a predicted use of the vehicle, or a combination thereof.

18. The non-transitory computer-readable storage medium of claim 17, wherein the apparatus is caused to further perform:
transmitting a reservation request to book a slot at the recommended location to replenish the remaining energy level of the vehicle at the recommended time.

19. The non-transitory computer-readable storage medium of claim 17, wherein the reservation request includes a request to book a shared vehicle for use while the remaining energy level of the vehicle is replenished at the recommended location.

20. The non-transitory computer-readable storage medium of claim 16, wherein the recommended time, the recommended location, or a combination thereof is further based on an energy replenishment mode of the vehicle, an energy replenishment connector of the vehicle, or a combination thereof.
